(19) United States
(12) Patent Application Publication
(10) Pub. No.: US 2015/0317045 A1
(43) Pub. Date: Nov. 5, 2015

(54) OPERATING METHOD AND OPERATING DEVICE

(71) Applicant: VOLKSWAGEN AKTIENGESELLSCHAFT, Wolfsburg (DE)

(72) Inventors: Michael MISCHKE, Hannover (DE); Manuel JOACHIM, Braunschweig (DE); Michael WITTKÄMPER, Braunschweig (DE)

(21) Appl. No.: 14/651,254

(22) PCT Filed: Dec. 2, 2013
(86) PCT No.: PCT/EP2013/075265

§ 371 Date: Jun. 11, 2015

(30) Foreign Application Priority Data
Dec. 11, 2012 (DE) 10 2012 024 215.8

(51) Int. Cl. G06F 3/0482; G06F 3/0484

(52) U.S. Cl. CPC G06F 3/0482; G06F 3/04842

(57) ABSTRACT

An operating method wherein a plurality of graphical objects are displayed at different display positions on a display surface, the display positions of the graphical objects are shifted in common by actuating an operating element arranged remotely from the display, and at least one graphical object is shown highlighted on the basis of the display position of the object relative to a stationary highlighting region of the display. The display positions of the graphical objects are shifted in common by actuating the operating element. Also disclosed is an operating device for carrying out the method.

### PRIORITY CLAIM

This patent application is a U.S. National Phase of International Patent Application No. PCT/EP2013/075265, filed 2 Dec. 2013, which claims priority to German Patent Application No. 10 2012 024 215.8, filed 11 Dec. 2012, the disclosures of which are incorporated herein by reference in their entirety.

### SUMMARY

Illustrative embodiments relate to an operating method and an operating device which are suitable for controlling a display with a multiplicity of graphical objects. For this purpose, in the operating method a multiplicity of graphical objects are displayed on a display surface at different display positions. The display positions of the graphical objects are shifted together by actuating an operating element which is arranged apart from the display surface. At least one graphical object is displayed marked relative to a fixed marking area of the display surface as a function of its display position. The operating device comprises a display surface on which it is possible to display a multiplicity of graphical objects at different display positions. Furthermore, the operating device comprises an operating element which is arranged apart from the display surface and a control device which is coupled to the display surface and the operating element, it being possible to shift the display positions of the graphical objects together by actuating the operating element, and it being possible for at least one graphical object to be displayed marked relative to a fixed marking area of the display surface as a function of its display position.

Disclosed embodiments provide an operating method and an operating device of the type mentioned at the beginning with which graphical objects can be marked as simply and intuitively as possible.

### BRIEF DESCRIPTION OF THE DRAWINGS

The disclosed information will now be explained with the aid of an exemplary embodiment and with reference to the drawings, in which:

FIG. 1 shows a diagram of the design of an exemplary embodiment of the operating device;

FIGS. 2-4 show displays on the display surface which are produced by an exemplary embodiment of the operating method;

FIGS. 5 and 6 show alternative options for displaying the marking of a graphical object in accordance with the exemplary embodiment of the operating method; and

FIG. 7 shows the display of a further exemplary embodiment of the operating method.

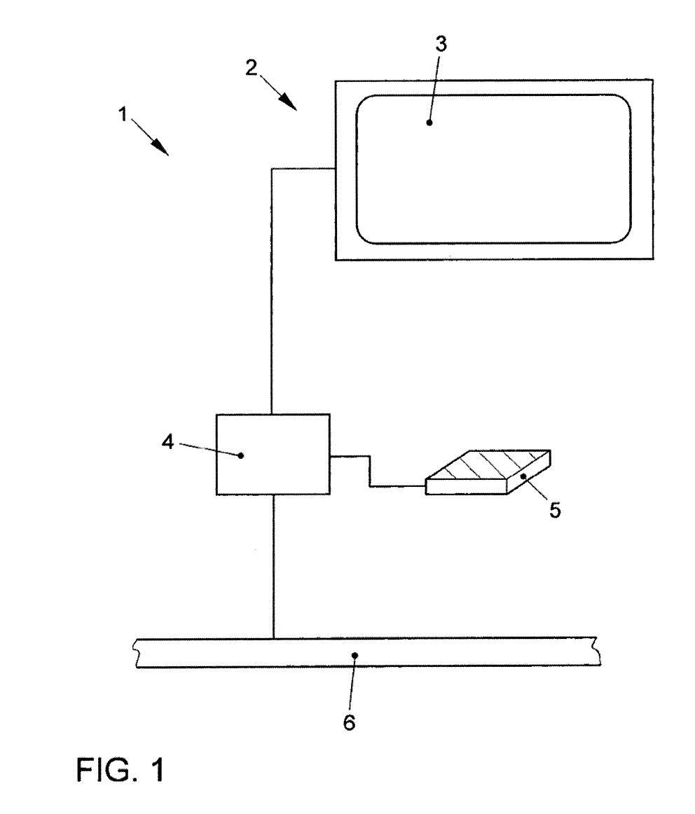

### DETAILED DESCRIPTION OF THE DISCLOSED EMBODIMENTS

When the display positions of the graphical objects are shifted together by actuating the operating element, it is checked whether a change in the marked object is to be initiated, the check being performed relative to the fixed marking area as a function of the display positions of the graphical objects. When the result of this check is that a change in the marked object is to be initiated, a beam-shaped display element is displayed which connects a display position within the fixed marking area with the object to be marked, and the graphical objects are then automatically shifted together so that the object to be marked is displayed in the marking area of the display surface.

In the case of the method, the display content is therefore shifted. When the display content represents a cutout of a larger virtual surface, graphical objects will disappear, as the case may be, in the shift, and new graphical objects will turn up. When the graphical objects are shifted together, the geometrical arrangement of the objects relative to one another will, in particular, be maintained in this case.

Furthermore, it is true that a marking area is defined in the method. However, no cursor is displayed which can be shifted by actuating the operating element. The user can therefore easily and intuitively grasp which elements of the display are being shifted upon actuation of the operating element. In this way, the user intuitively recognizes that, to mark an object, he must shift the graphical objects together by means of actuating the operating element so that the object to be marked approaches the marking area. In this case, the marking area can be located, in particular, in the middle of the display surface. The object originally marked is moved away from the marking area in this way. When another graphical object is located closer to the marking area than is the previously marked object, the beam-shaped display element appears. The beam-shaped display element symbolizes a laser beam which is directed out of the marking area onto the graphical object which is currently closest to the marking area. In this way, the user can intuitively grasp which graphical object is marked as the next one given the disposition of the display objects. When the user does not then move another graphical object into the vicinity of the marking area, the graphical objects are automatically shifted together so that the graphical object onto which the beam-shaped display element was being directed is displayed in the marking area and appropriately marked. Automatic shifting of the objects is understood in this case to mean that there is no need for the user to move the display element to be marked exactly to the marking area by actuating the operating element. Once the connection to the object to be marked has been made via the beam-shaped display element, it is automatically shifted into the marking area and marked.

The user is thereby given feedback concerning the outcome of his actuation via the operating element, and a graphical object in the vicinity of the marking area is, figuratively speaking, captured by the marking area. In addition, by actuating the operating element the user can bring objects into the image cutout displayed by the display surface.

In accordance with at least one disclosed embodiments of the operating method, during the check as to whether a change is to be initiated in the marked object, it is checked whether the display position of another graphical object is closer to the fixed marking area than is the display position of the currently marked graphical object. Such a selection of a new marked object can be accomplished in a particularly intuitive fashion by the user. It is always the graphical object which is closest to the marking area which is automatically marked.

In accordance with a further disclosed embodiment of the method, at least one graphical adhesive element is displayed which touches the marked object when it is displayed in the marking area. In particular, a plurality of graphical adhesive elements are arranged at the ends of lines whose extensions intersect at the marked graphical object. On the one hand, the lines visualize the position of the marking area. The adhesive elements intuitively visualize for the viewer that the object which the adhesive elements touch is marked. In this case, the adhesive elements symbolize an adhesive which holds the marked object in the marking area.

In accordance with a further disclosed embodiment of the method, a vignette is inserted when a user touches the operating element. Areas of the display surface which are remote from the marked object are displayed in dimmed fashion through the vignette. This type of display makes use of a visual effect known from photography to direct the user's attention to the marked object when the former touches the operating element to begin an actuation process.

In accordance with a further disclosed embodiment of the operating method, a corona or a light frame is displayed around the marked object or the object to be marked. Here, a corona is understood to be a garland-like faint glow around the graphical object. In this way, the user can quickly and intuitively grasp which object is marked or which object is being marked.

In accordance with a further disclosed embodiment of the operating method, the marked object is displayed at its largest, and adjacent graphical objects are displayed in a smaller fashion, the size of the adjacent graphical objects becoming smaller with increasing distance from the marked object. At the same time, the objects can also be displayed as distorted in a way which would result when viewing through a so-called fisheye lens. In this case, the center of the fisheye display is the center of the marked graphical object. It is also easily possible in this way for the user to grasp which object is marked by visualization.

In the operating device, when the display positions of the graphical objects are shifted together by actuating the operating element, it is possible for the control device to check whether a change in the marked object is to be initiated, the check being performed relative to the fixed marking area as a function of the display positions of the graphical objects. When the result of the check is that a change in the marked object is to be initiated, the display surface can be controlled by means of the control device so that a beam-shaped display element is displayed which connects a display position within the fixed marking area with the object to be marked, and the graphical objects are then automatically shifted together so that the object to be marked is displayed in the marking area of the display surface.

The operating device is, in particular, designed to execute the disclosed operating method. In particular, the operating element of the operating device comprises a touch-sensitive surface. A so-called touchpad is thereby provided.

The operating device is arranged, in particular, in a motor vehicle. In this case, the touch-sensitive surface of the operating element is located in the reach of the driver of the vehicle when he is sitting on the driver's seat. By contrast, the display surface is located in the main field of view of the driver. It can, for example, be arranged in the center console or in the so-called instrument cluster of the vehicle. Furthermore, the display surface can also be included in a headup display so that the display is projected into the windscreen of the motor vehicle.

Similarly, the operating device can, however, also be used for displays in the industrial sector or in computer applications.

The operating device 1 comprises a display device 2 having a display surface 3. The display surface 3 can be provided by a display of any desired type, in particular a liquid crystal display.

The operating device 1 comprises, furthermore, a control device 4 which is connected to the display device 2. Graphic data for displaying information on the display surface 3 can be produced by means of the control device 4. Furthermore, an operating element 5 is connected to the control device 4, which comprises a touch-sensitive surface. The operating element 5 is set apart, that is to say arranged remote from the display surface 3.

Finally, the control device 4 is connected to a data bus 6 via which it is possible to transmit to the control device 4 data from functional devices whose operation is to be supported by the display on the display surface 3. Furthermore, control data can be transmitted via the data bus from the control device 4 to the appropriate functional devices.

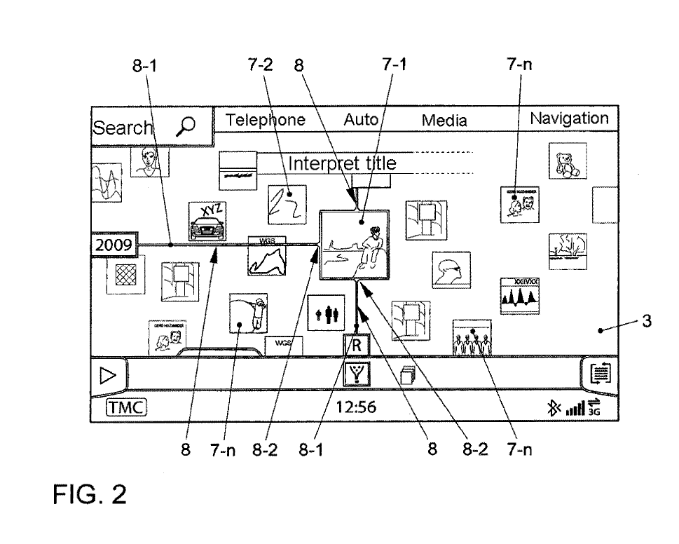

An exemplary embodiment of the method which can be executed by the operating device 1 is explained below with reference to FIGS. 2 to 4:

For the purpose of display on the display surface 3, a virtual surface is defined on which a multiplicity of graphical objects are arranged which are denoted in general as 7-n. A cutout of the virtual surface with a subset of the graphical objects 7-n is displayed on the display surface 3.

A marking area is defined in the middle of the display surface 3. The graphical object 7-1 located at the marking area is marked. Associated further functions can be called to a marked graphical object 7-1. In the example explained here, the graphical object 7-1 is assigned a music file. The music file can be played by a specific operating procedure.

Graphical display elements 8 for visualizing that the graphical object 7-1 is marked are displayed. They comprise three lines 8-1 whose extensions intersect in the middle of the marked graphical object 7-1 and in the middle of the marking area. Displayed at the ends of the lines 8-1 are graphical adhesive elements 8-2 which touch the graphical element 7-1 and which symbolize adhesion of the graphical element 7-1 in the marking area.

If the user now wishes to mark another graphical object 7-n, for example the graphical object 7-2, to play the piece of music assigned to the graphical object 7-2, the user touches the touch-sensitive surface of the operating element 5. When he has touched the touch-sensitive surface, a vignette is inserted through which areas, remote from the currently marked object 7-1, of the display surface 3 are represented in a dimmed fashion. The currently marked object 7-1 is thereby emphasized again for the operating procedure.

If, by way of example, the user now moves his fingertip on the touch-sensitive surface of the operating element 5, the graphical objects 7-n are shifted together on the touch-sensitive surface in accordance with the movement of the fingertip. In the example described here, for example the user moves his fingertip to the right on the touch-sensitive surface. During the movement, the control device 4 is used to check which of the graphical objects 7-1 is arranged closest to the marking area, that is to say to the center of the display surface 3 in the present case. When the graphical object 7-1, which is currently marked, is no longer closest to the marking area, but another graphical object 7-n is, the control device 4 initiates a change in the marked object 7-n.

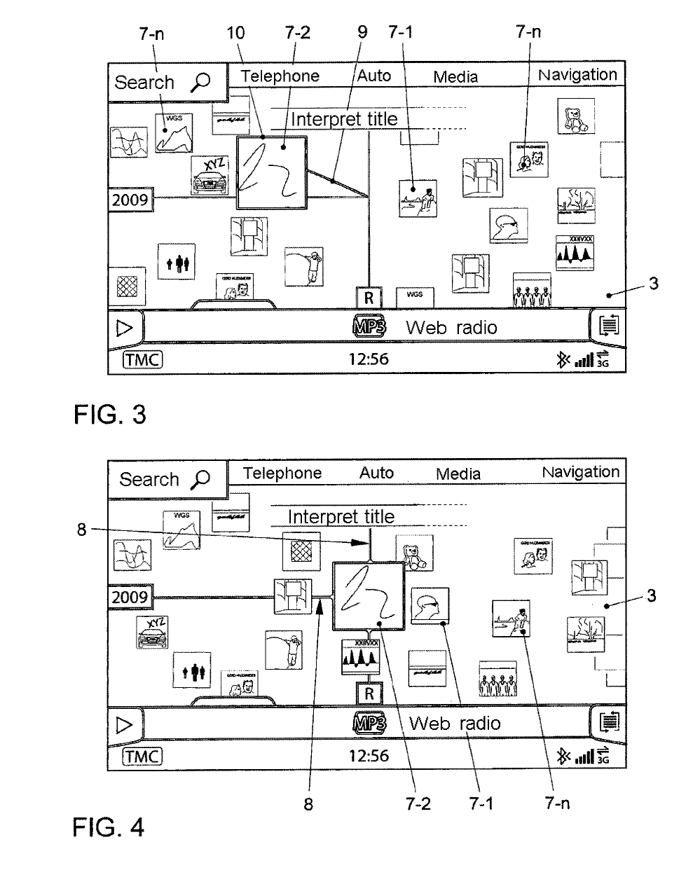

FIG. 3 shows the case in which the graphical object 7-2 is located closer to the marking area than is the previously marked graphical object 7-1. The graphical object 7-2 is thereupon displayed in changed fashion by means of the control device 4: firstly, it is enlarged and correspondingly moves away somewhat from the marking area, a corona 10 is illustrated around the graphical object 7-2, and the graphical object 7-2 itself is displayed more brightly. Furthermore, a beam-shaped display element 9 is shown that connects to the object 7-2 to be marked a display position within the fixed marking area, in the present case the center of the display surface 3.

If the user now does not execute a movement with his fingertip on the touch-sensitive surface of the operating element 5, that is to say rests for a specific time interval with his fingertip on the touch-sensitive surface, the graphical object 7-2 to be marked is shifted together with the other graphical objects 7-n automatically, that is to say without actuation of an operating element 5 by the user, so that it is displayed in the marking area of the display surface 3. This is reproduced in FIG. 4.

As has already been described with reference to FIG. 2, the graphical object 7-2 now marked is displayed in FIG. 4 with the aid of the display elements 8.

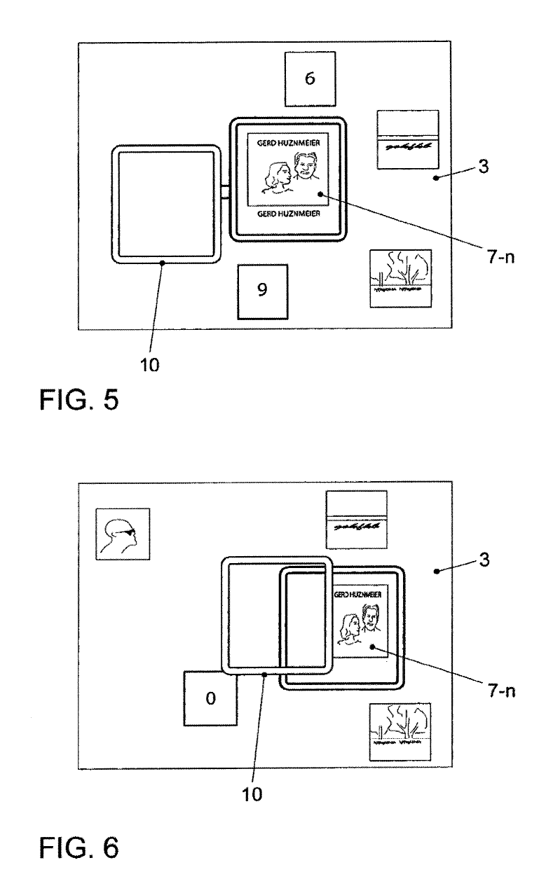

Alternative displays of the operating method are reproduced in FIGS. 5 to 7. A light frame 10 is displayed around the object 7-n marked or to be marked in the case of the configurations in accordance with FIGS. 5 and 6. The remaining objects 7-n, which are not marked, are displayed in dimmed fashion in this case.

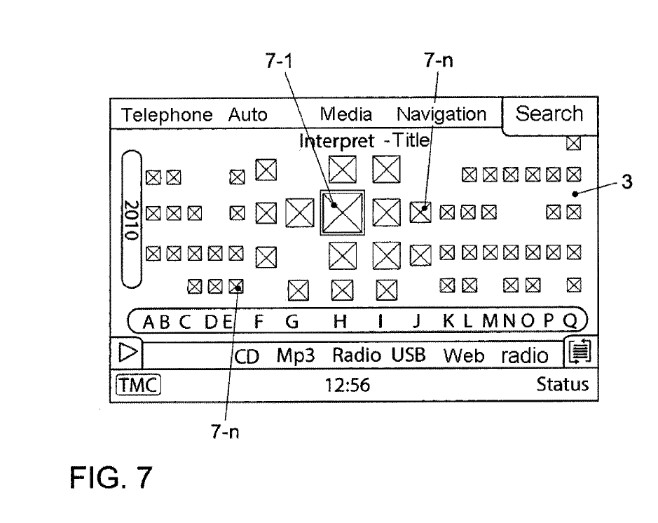

In the case of the configuration shown in FIG. 7, the marked graphical object 7-1 is displayed at its largest in the middle of the display surface 3. The other graphical objects 7-n are displayed in a smaller fashion, the size of the objects 7-n decreasing with increasing distance from the object 7-1. In this case, the graphical objects 7-1 could also be displayed in distorted fashion such as would result from viewing through a fisheye lens. When the graphical objects 7-n are shifted in this case or in the context of the above-described exemplary embodiments, the size of the graphical objects 7-n is changed, specifically the size of a graphical object 7-n then being a function of its distance from the fixed marking area.

In the case of known operating methods in which operating elements apart from the display surface are used, use is made on the display surface of a marker, also denoted as a cursor, which visualizes operations via the operating element. The position of the marker can be changed on the display surface. It is known, furthermore, to shift the display content relative to a fixed marker.

There is an operating method known for the term “bubble cursor” in which a selection of graphical objects is made outside a screen cutout by virtue of the fact that the cursor remains at the edge of the current cutout until the display content passes through under the cursor, that is to say there is a change in the image cutout displayed. It is therefore necessary in this operating method for the user to execute constant visual control as to whether the cursor has already marked the correct object and the display content has been correctly shifted. This is particularly disadvantageous in the case of use in a motor vehicle, since it is desirable in such a case for the user to have to view the display surface only briefly to mark a graphical object.

Furthermore, an operating method for the display of a navigation system is known in which a crosshair is displayed as marker, and the geographical map displayed is shifted relative to the crosshair by means of the operating element. This results in the problem that the user first has to recognize what has been moved by the actuation of the operating element: the crosshair or the geographical map.

US 2009/0172532 A1 discloses an operating method which is, for example, used in a media player. Various graphical objects which represent various media are displayed on a display surface. The user can control display of the graphical objects through specific operating gestures.

WO 2010/018126 A1 describes a menu on the screen of a cellphone in which a set of icons are arranged on a convex portion, represented in three dimensions, of a virtual ball. In this case, the display surface is designed as a touch screen. The ball displayed can be rotated by touch gestures to bring other icons to the display.

DE 10 2010 042 326 A1 discloses a display control device for a remote control device. In the device, a cursor is displayed as a figure which highlights an outer edge of a selected symbol, or which highlights a color or brightness of a selected symbol.

DE 10 2009 037 658 A1 discloses a display device which displays graphical objects and a cursor display. A plurality of functions are assigned to the objects. The distance of the cursor display from a graphical object can be changed by means of an operating device. When a distance of the cursor display from an object is reduced below a predetermined value, the object is selected in this case. One of the functions assigned to the selected object can then be selected via a voice command.

Finally, DE 10 2009 019 818 A1 discloses an operating and display system for a vehicle with multifunction operating units, and DE 10 2009 038 044 A1 discloses a method for operating an operating device of a vehicle in the case of which a so-called touchpad is used.

### LIST OF REFERENCE NUMERALS

1 Operating device
2 Display device
3 Display surface
4 Control device
5 Operating element
6 Data bus
7-1, 7-2, 7-n Graphical objects
8 Display element
8-1 Lines
8-2 Graphical adhesive element
9 Beam-shaped display element
10 Light frame

1. An operating method comprising:
displaying a multiplicity of graphical objects on a display surface at different display positions;
shifting together the display positions of the graphical objects by actuating an operating element arranged apart from the display surface; and
displaying at least one graphical object as marked relative to a fixed marking area of the display surface as a function of its display position,
wherein, when the display positions of the graphical objects are shifted together by actuating the operating element, it is checked whether a change in the marked object is to be initiated, the check being performed relative to the fixed marking area as a function of the display positions of the graphical objects, and
wherein, when the result of the check is that a change in the marked object is to be initiated, a beam-shaped display element is displayed which connects a display position within the fixed marking area with the object to be marked, and the graphical objects are then automatically shifted together so that the object to be marked is displayed in the marking area of the display surface.

2. The operating method of claim 1, wherein, during the check as to whether a change is to be initiated in the marked object, it is checked whether the display position of another graphical object is closer to the fixed marking area than is the display position of the currently marked graphical object.

3. The operating method of claim 1, wherein, when a marked object is displayed in the marking area, at least one graphical adhesive element is displayed which touches the marked object.

4. The operating method of claim 3, wherein graphical adhesive elements are arranged at the ends of lines whose extensions intersect at the marked graphical object.

5. The operating method of claim 1, wherein a vignette is inserted when a user touches the operating element through which areas of the display surface which are remote from the marked object are displayed in dimmed fashion.

6. The operating method of claim 1, wherein a corona is displayed around the marked object or the object to be marked.

7. The operating method of claim 1, wherein a light frame is displayed around the marked object or the object to be marked.

8. The operating method of claim 1, wherein the marked object is displayed at its largest, and adjacent graphical objects are displayed in a smaller fashion, the size of the adjacent graphical objects becoming smaller with increasing distance from the marked object.

9. The operating method of claim 8, wherein the sizes of the graphical objects change when the graphical objects are shifted together by actuating the operating element, the size of a graphical object being a function of its distance from the fixed marking area.

10. An operating device, comprising
a display surface on which it is possible to display a multiplicity of graphical objects at different display positions;
an operating element arranged apart from the display surface; and
a control device coupled to the display surface and the operating element, it being possible to shift the display position of the graphical objects together by actuating the operating element and it being possible for at least one graphical object to be displayed marked relative to a fixed marking area of the display surface as a function of its display position,
wherein, when the display positions of the graphical objects are shifted together by actuating the operating element, it is possible by means of the control device to check whether a change in the marked object is to be initiated, the check being performed relative to the fixed marking area as a function of the display positions of the graphical objects, and
wherein, when the result of the check is that a change in the marked object is to be initiated, the display surface can be controlled by means of the control device so that a beam-shaped display element is displayed which connects a display position within the fixed marking area with the object to be marked, and the graphical objects are then automatically shifted together so that the object to be marked is displayed in the marking area of the display surface.
